(19) United States
(12) Patent Application Publication
(10) Pub. No.: US 2012/0104764 A1
(43) Pub. Date: May 3, 2012

(54) WIND POWER GENERATOR USING AN AUTOMATICALLY FOLDABLE CANOPY

(76) Inventor: Jaehark Goo, Seoul (KR)

(21) Appl. No.: 13/381,857

(22) PCT Filed: Jul. 6, 2010
(86) PCT No.: PCT/KR2010/004389

§ 371 Date: Dec. 30, 2011

(30) Foreign Application Priority Data
Jul. 7, 2009 (KR) 10-2009-0061600

(51) Int. Cl. F03D 9/00

(52) U.S. Cl. 290/55

(57) ABSTRACT

A wind power generator using an automatically foldable canopy is provided, which includes a steel tower unit which is supported on the ground and installed up to a predetermined height; a shank unit connected to the top of the steel tower and installed in the horizontal direction; a spreadable body having a canopy which repeats folding and unfolding operations in the direction of the wind along the shank unit; a main rope connected to a plurality of strings connected to the rim of the canopy, and extending to the steel tower; and a generating unit installed in the steel tower to generate energy by the difference in wind pressure between the wound mode and unwound mode of the main rope.

### TECHNICAL FIELD

The present invention relates to a wind power generating apparatus using an automatically foldable canopy and, more particularly, to a wind power generating apparatus, which generates electric power by employing an energy difference based on a difference in the wind pressure according to a difference in the area of an automatically foldable canopy of an umbrella form when the canopy is repeatedly folded and unfolded in the wound mode and the unwound mode of a main rope.

### BACKGROUND ART

A common wind power generator is chiefly using a rotor blade, that is, a windmill structure, such as a propeller. The windmill structure is not efficient in terms of wind power energy per area because the area of the blade coming in contact with a wind when the blade is rotated in a direction at a right angle to the wind is small.

Furthermore, for a large size for increasing the area of the blade, the manufacturing cost and the installation cost are sharply increased because the support structure of the blade becomes large and heavy.

There are methods using a sail, a kite, etc. in addition to the windmill structure. The methods employ force generated when a wind acts almost at a right angle to a relatively wide area. A variety of methods may be applied to a wind power generator, and the prior arts using the methods are described in short below.

First, U.S. Pat. No. 6,498,402 relates to a wind catchment device using a sail form. In this method, pulleys are provided in each of two or more pylons disposed in the upwind and downwind directions, belt-shaped strings are connected between the pylons so that the pulley are rotated, and a plurality of parachutes is provided in each of the strings at specific intervals, thereby obtaining energy based on a difference in the wind pressure when a position with which a wind comes in contact upon reciprocation is changed by the rotation of the parachutes by the belts.

In the wind catchment device, however, the wind of a back parachute is hindered by a front parachute because the plurality of parachutes is installed in succession, and there is a difficulty in increasing the size of the spreadable unit of the parachute in view of its structure. Furthermore, there are disadvantages in that efficiency is low because the direction of the wind is not accurately matched with the axial direction of the parachutes, a plurality of the pylons is required, and a wide flatland for installation is necessary.

Another prior art is a method written in U.S. Pat. No. 7,275,719. This method has a structure in which one kite or a plurality of kites flies, a ring is connected to a string connected to the fixed kite, and a sail performs reciprocal operations in the upwind and downwind directions along the fixed kite string.

Several strings are installed in the sail that reciprocates in the upwind and downwind directions so that the sail is widen or narrowed by tension of the strings, thereby generating electric power. A power generation system using this method is advantageous in that it may use a wind at the high altitude of the atmosphere having a great wind velocity, but is disadvantageous in that the sway of the kite is great according to the state of a wind and the reciprocation operation of the sail is not smooth because the string between the ground and the kite is not parallel to a wind. Furthermore, there is a problem in that energy loss is generated in terms of an actual operation because several strings have to be controlled at the same time.

Meanwhile, yet another prior art is a method written in Korean Patent Registration No. 805583. A wind power generator written in the prior art has a structure in which a drop curtain is installed between two steel towers by using four strings and electric power is generated by unfolding the drop curtain in the downwind direction and folding the drop curtain in the upwind direction.

This wind power generating method can be operated only when the direction of the wind is vertical between the two steel towers and is disadvantageous in that the structure is complicated, the installation cost is great, and control is difficult because an angle of the drop curtain must be controlled so that the angle becomes vertical or horizontal to the direction of the wind by using a winch and a synchronization electric generator which are installed in each of four independent strings.

As described above, the methods of generating electric power using the sail or the kite are disadvantageous in that the structure is complicated, the installation cost is great, and relevant efficiency is low because most of the methods require several control strings or steel towers and an operating state is varied according to the direction of the wind.

### DISCLOSURE

### Technical Problem

Accordingly, the present invention has been made in view of the above problems occurring in the conventional wind power generators, and it is an object of the present invention to provide a wind power generating apparatus using an automatically foldable canopy, which generates electric power by employing an energy difference based on a difference in the wind pressure according to a difference in the area of the automatically foldable canopy of an umbrella form when the unwound mode and the wound mode of a main rope are repeatedly performed simultaneously with the unfolding operation or the folding operation of the canopy which is automatically folded and unfolded by a wound mode latch and an unwound mode latch included in a shank unit.

### Technical Solution

The object of the present invention is achieved by a wind power generating apparatus using an automatically foldable canopy, including a steel tower unit supported on the ground and installed to a specific height, a shank unit connected to the top of the steel tower unit and installed in a horizontal direction, a spreadable body equipped with the canopy which repeats folding and unfolding in a downwind direction on the shank unit, a main rope configured to connect a plurality of strings to the rim of the canopy and extended to the steel tower unit, and a generating unit installed in the steel tower unit and configured to generate energy by a difference in the wind pressure between the wound mode and the unwound mode of the main rope.

The steel tower unit includes support units supported on the ground in a vertical direction, a bearing connected to the top of the support units and configured to enable horizontal rotation in the downwind direction, a pulley mounted on the top of the bearing and configured to guide the transfer of the main rope, and a string ring fixing pole configured to fix the string ring, connected to the strings, to the support units when the spreadable body approaches the support units.

Furthermore, the shank unit includes a shank post configured to have the canopy connected thereto so that the canopy is unfoldable and foldable, an unwound mode latch and a wound mode latch installed in the shank post and configured to move the spreadable body in the unwound or wound mode of the main rope and to have a string ring, connected to the strings, engaged with the shank post, and a canopy tap fixture configured to have a canopy tap, mounted on the canopy, fixed to the shank post.

Furthermore, the spreadable body may include the canopy configured in an umbrella form, a specific number of the strings connected to the canopy, a string ring configured to gather and connect the strings, and a canopy tap placed at the vertex of the canopy.

Furthermore, the generating unit may include an electric generator configured to generate electric power in the unwound mode of the main rope, a motor configured to wind the main rope using motive power in the wound mode of the main rope, a winch connected to the electric generator and the motor and configured to wind or unwind the main rope by rotation, and a control plate configured to control the rotation of the winch.

The wind power generating apparatus constructed as described above according to the present invention has a technical characteristic in that electric power is generated by an energy difference generated when the main rope connected to the shank post is wound or unwound through the winch of the generating unit by means of a difference in the wind pressure which is generated in a process in which the canopy mounted on the spreadable body repeats folding and unfolding on the shank post by the wind pressure and the shank post is folded and unfolded.

More particularly, the main rope connected to the strings of the canopy is connected to the generating unit, and the wound mode and the unwound mode of the main rope are performed by the repetition of the folding and unfolding of the canopy. When the unwound mode of the main rope is finished in the state in which the canopy is unfolded and subjected to wind pressure, the string ring is released from the unwound mode latch. The string ring released from the unwound mode latch is moved on the shank post in the downwind direction by means of the wind pressure without additional power and is then supported by the wound mode latch. Accordingly, the folding of the canopy is performed.

Furthermore, in the state in which the canopy is folded and subjected to minimum wind pressure, the main rope is wound by the motor and thus the string ring is fixed to the string ring fixing pole. At this time, the canopy is unfolded so that the string ring supported by the wound mode latch can be supported by the unwound mode latch by means of wind force without additional power.

The wind power generating apparatus constructed as described above according to the present invention has a technical characteristic in that energy is obtained by a difference in the work generated through the unwound mode and the wound mode of the main rope in such a manner that, in the unwound mode in which the spreadable body is unfolded on the shank post by the wind and thus moved in the direction of the wind, the spreadable body is subjected to maximum wind pressure through the canopy and thus the main rope connected to the electric generator is extended to generate electric power and, in the wound mode in which the spreadable body is folded on the shank post and the main rope is wound through the motor and thus moved in the upwind direction, minimum wind pressure is applied to the canopy.

### Advantageous Effects

As described above, in the wind power generating apparatus using an automatically foldable canopy according to the present invention, electric power is generated by employing an energy difference based on wind power in a process in which the canopy is automatically folded and unfolded. Accordingly, there are advantages in that efficiency is excellent because a wind is received in the face through the canopy and the installation cost is low.

Furthermore, in the present invention, an operation of the canopy being folded and unfolded is based on a principle that an umbrella is blown inside out. Accordingly, there are advantages in that a construction is simple and the canopy is easily controlled because additional power is not necessary to fold and unfold the canopy. Furthermore, there is an advantage in that recovery efficiency of wind power energy is improved because electric power is stably generated irrespective of the direction of the wind.

### DESCRIPTION OF DRAWINGS

FIG. 1 shows a construction in the unwound mode of a wind power generating apparatus according to the present invention.

FIG. 2 shows a construction in the wound mode of the wind power generating apparatus according to the present invention.

FIG. 3 shows a construction of an upper portion of the steel tower of the wind power generating apparatus according to the present invention.

FIGS. 4 to 9 show operational constructions for the respective modes of the wind power generating apparatus according to the present invention.

FIGS. 10 and 11 show positional relationships of a string ring to a shank unit which is adopted in the wind power generating apparatus according to the present invention.

FIG. 10 shows a construction in the unwound mode state of a main rope.

FIG. 11 shows a construction in the wound mode state of the main rope.

FIG. 12 is a detail diagram of an unwound mode latch which is applied to the wind power generating apparatus according to the present invention.

FIG. 13 shows a positional relationship of the shank unit and the string ring to a string ring fixing pole at a wound mode end point which is applied to the wind power generating apparatus according to the present invention.

FIG. 14 shows a positional relationship of the shank unit and the string ring to the string ring fixing pole from a wound mode end point to an unwound mode start point which is applied to the wind power generating apparatus according to the present invention.

FIG. 15 shows a positional relationship of the shank unit and the string ring to the string ring fixing pole at the unwound mode start point which is applied to the wind power generating apparatus according to the present invention.

FIG. 16 shows a construction of the string ring fixing pole which is applied to the wind power generating apparatus according to the present invention.

<Description of reference numerals of principal elements in the drawings>

| | |
|---|---|
| 100. steel tower unit | 200. shank unit |
| 300. spreadable body | 400. main rope |
| 500. generating unit | |

### MODE FOR INVENTION

The contents regarding acting effects in addition to the technical construction of the object of the wind power generating apparatus according to the present invention will be evidently understood through the following detailed description described with reference to the accompanying drawings showing preferred embodiments of the present invention.

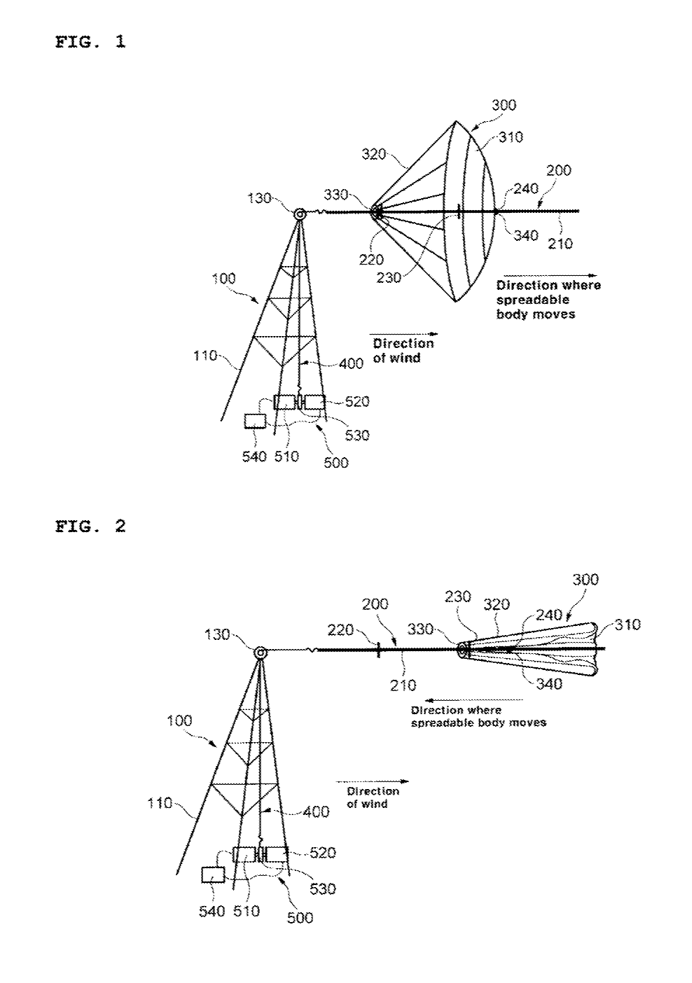

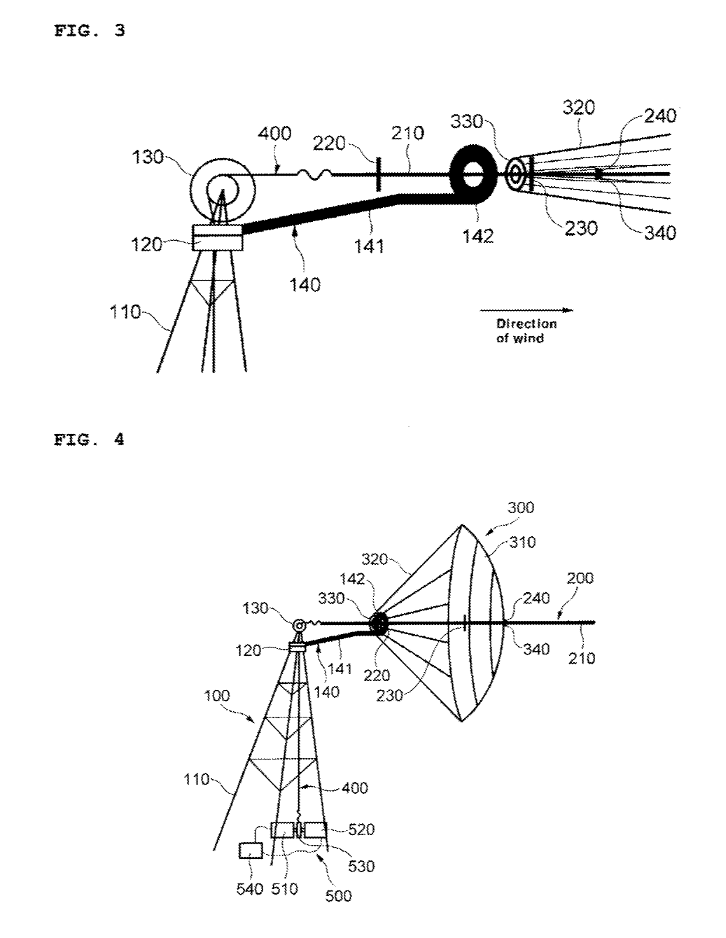

First, FIG. 1 shows a construction in the unwound mode of a wind power generating apparatus according to the present invention, FIG. 2 shows a construction in the wound mode of the wind power generating apparatus according to the present invention, and FIG. 3 shows a construction of an upper portion of the steel tower of the wind power generating apparatus according to the present invention.

As shown, the wind power generating apparatus according to an embodiment of the present invention chiefly includes a steel tower unit 100, a shank unit 200 horizontally installed at the top of the steel tower unit 100, a spreadable body 300 mounted on the shank unit 200 so that the spreadable body 300 can be folded and unfolded in the upwind and downwind directions, a main rope 400 connected to a plurality of strings 320 connected to the canopy 310 of the spreadable body 300 and extended into the steel tower unit 100, and a generating unit 500 installed in the steel tower unit 100.

Here, the spreadable body 300 is equipped with the canopy 310 which is independently unfolded in the downwind direction by means of a wind flown from the upper side of the steel tower unit 100.

The spreadable body 300 includes the canopy 310 formed in the same form as the fabric part of an umbrella, the plurality of strings 320 connected to the rim of the canopy 310, a string ring 330 configured to collectively connect the strings 320, and a canopy tap 340 installed at the vertex of the canopy 310 when the canopy 310 is folded.

Furthermore, the shank unit 200 includes a shank post 210, such as one corresponding to the post of an umbrella, an unwound mode latch 220 configured to have the string ring 330 engaged with a specific point of the shank post 310 while the spreadable body 300 is moved in a downwind direction, a wound mode latch 230 configured to have the string ring 330 engaged with a specific point of the shank post 210 when the string ring 330 is moved by the wounding of the main rope 400, and a canopy tap fixture 240 configured to fix the canopy tap 340 when the canopy 310 is initially installed.

Furthermore, the steel tower unit 100 may include support units 110 vertically supported on the ground to a specific height, a bearing 120 placed on the upper part of the support units 110 and configured to have the shank post 210 rotated in a direction horizontal to the direction of the wind, a pulley 130 connected to the top of the bearing 120 and configured to guide the main rope 400, and a string ring fixing pole 140 connected to the top of the bearing 120 and configured to fix the string ring 330 to the support units 110 when the spreadable body 300 moves and approaches the support units 110.

Meanwhile, the generating unit 500 may include an electric generator 510 configured to have one end of the main rope 400 connected thereto and to generate electric power, a motor 520 configured to wind the main rope 400 when the canopy 310 is folded, a winch 530 connected to the electric generator 510 and the motor 520 and configured to wind or unwind the main rope 400 and control the winding or unwinding of the main rope 400, and a control plate 540.

A connection relationship between the elements configured as described above is described in more detail below with reference to FIGS. 1 to 3.

First, the spreadable body 300 includes the canopy 310 configured to have the same form as an umbrella and the plurality of strings 320 connected to the rim portion of the canopy 310. The plurality of strings 320 is gathered and connected into one by the string ring 330.

Furthermore, the canopy tap 340 of a hole form is formed in a tap which is the center of the folding and unfolding of the canopy 310. When the canopy 310 is initially installed, the shank post 210 is inserted into the canopy tap 340 so that it is permanently installed in the shank unit 200.

In the shank unit 200, the unwound mode latch 220 equipped with an automatic release function and the wound mode latch 230 placed in a more downward direction than the unwound mode latch 220 are included in the shank post 210 formed of a bar-shaped rod or a string. The canopy tap fixture 240, placed in a more downward direction than the wound mode latch 230 and configured to have the canopy tap 340 permanently fixed to the shank post 210, is installed in the shank post 210.

The unwound mode latch 220 functions to have the string ring 330 engaged therewith or automatically released therefrom by means of wind pressure applied to the canopy 310 in the unwound mode of the main rope 400. The wound mode latch 230 functions to have the string ring 330, released from the unwound mode latch 220, engaged and fixed thereto in the wound mode of the main rope 400.

Meanwhile, the canopy 310 unfolded from the shank post 210 by means of a wind is connected to the string ring 330 through the plurality of strings 320. A mode where the shank post 210 has been moved in the downwind direction to the support units 110 of the steel tower unit 100 by wind pressure in the state in which the canopy 310 has been unfolded as described above is called an unwound mode state. Here, the unwinding of the main rope 400 is performed by the movement of the canopy 310.

In the unwound mode of the main rope 400, as in FIG. 1, the string ring 330 is supported by the unwound mode latch 220 and wind power is transferred to the main rope 400 through the movement of the shank post 210 in the downwind direction. The wind power is transferred to the electric generator 510 to which the end of the main rope 400 is connected via the pulley 130, installed in the steel tower unit 100, and the winch 530 through the main rope 400, thereby generating electric power.

Meanwhile, the canopy 310 unfolded by the wind pressure is moved in the downwind direction by the release of the unwound mode latch 220 and then folded in the form of an umbrella which has been turned inside out. At this time, the string ring 330 supported by the unwound mode latch 220, together with the canopy 310, is moved to one side and then supported by the wound mode latch 230. This form is called a wound mode state, such as that shown in FIG. 2.

The construction of the steel tower unit and the construction of the shank unit connected to the steel tower unit are described below with reference to FIG. 3. The steel tower unit 100 is configured so that the bearing 120 is installed at the top of the support units 110, the bearing 120 has upper and lower ends relatively horizontally rotated and has a through hole (not shown) formed at a central portion thereof, and the main rope 400 passes through the bearing 120 from an upper portion to a lower portion thereof.

Furthermore, the lower end of the bearing 120 is fixed to the top of the support units 110, and the pulley 130 and the string ring fixing pole 140 are fixed to the upper end of the bearing 120. Furthermore, the main rope 400 connected to the shank unit 200 penetrates a rope guidance ring 142 formed in a doughnut-shaped ring form at the center of the string ring fixing pole 140. The main rope 400 is connected to the winch 530 (refer to FIG. 1) which is installed on the lower side of the support units 110 through the pulley 130 and the bearing 120.

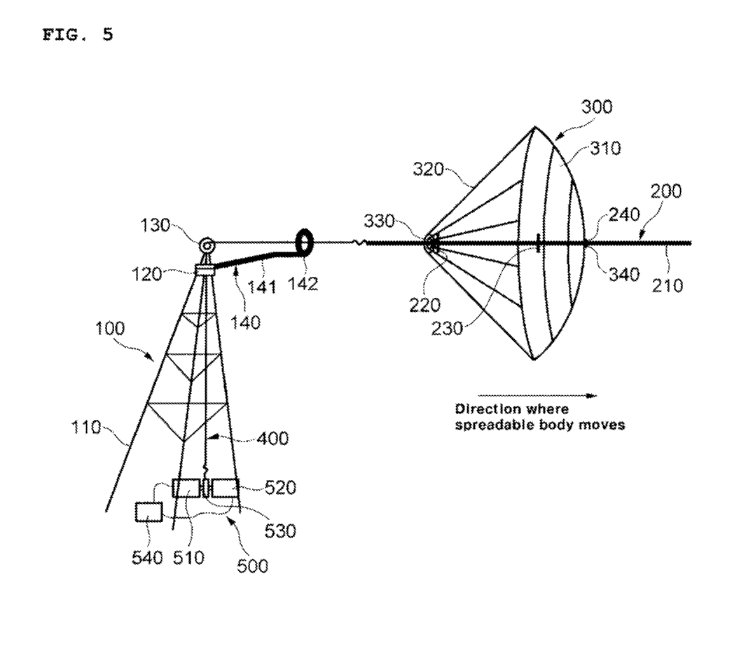

The folding and unfolding structures of the canopy in the wind power generating apparatus according to the present embodiment and a corresponding wind power generation structure are described in more detail below with reference to FIG. 4.

FIG. 4 shows an operational construction for each mode of the wind power generating apparatus according to the present embodiment.

First, a state, such as that shown in FIG. 4 in which the string ring 330 having the plurality of strings 320 connected thereto is supported by the unwound mode latch 220 included in the shank post 210 so that the canopy 310 is unfolded in the state in which the canopy 310 mounted on the shank post 210 is hit by a wind and the canopy 310 is unfolded at a position near the steel tower unit 100 as described above, is called an unwound mode start point.

The canopy 310 unfolded in the unwound mode start point is experienced by continuous wind pressure, the shank unit 300 in itself is moved in the downwind direction along with the spreadable body 200 by means of the wind pressure applied to the canopy 310, and the main rope 400 connected to the shank post 210 of the spreadable body 200 is released through the winch 530, so that the electric generator 510 generates electric power.

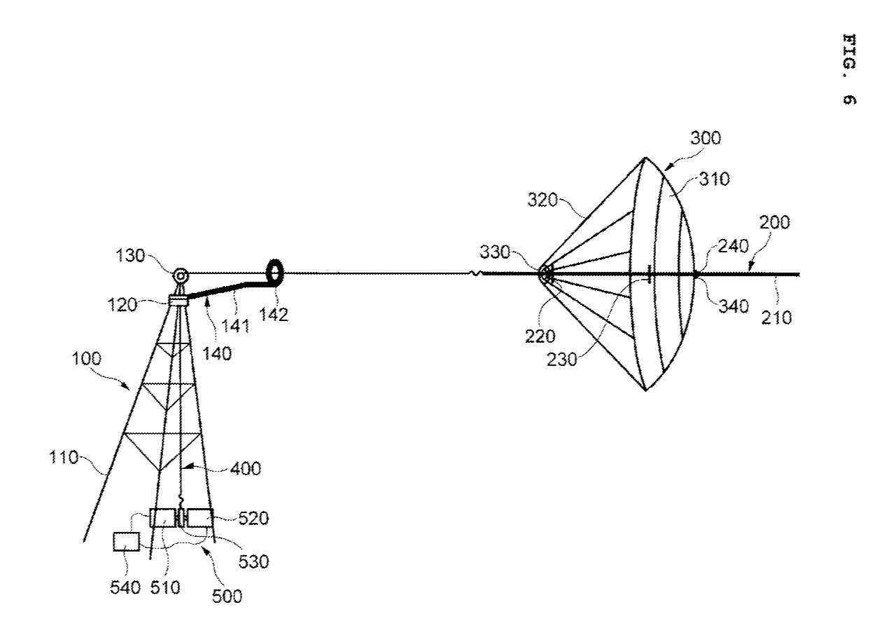

This time is called the unwound mode, such as that shown in FIG. 5. As wind pressure applied to the canopy 310 maintains a maximum, maximum wind power is transferred to the electric generator 510 through the main rope 400.

Furthermore, a state in which the main rope 400 has been released to a maximum degree in the state in which continuous wind pressure is applied to the canopy 310 and the shank post 210 has been moved in the downwind direction as shown in FIG. 6 is called an unwound mode end point. In this state, the main rope 400 is released to a maximum degree and thus the shank post 210 is stopped.

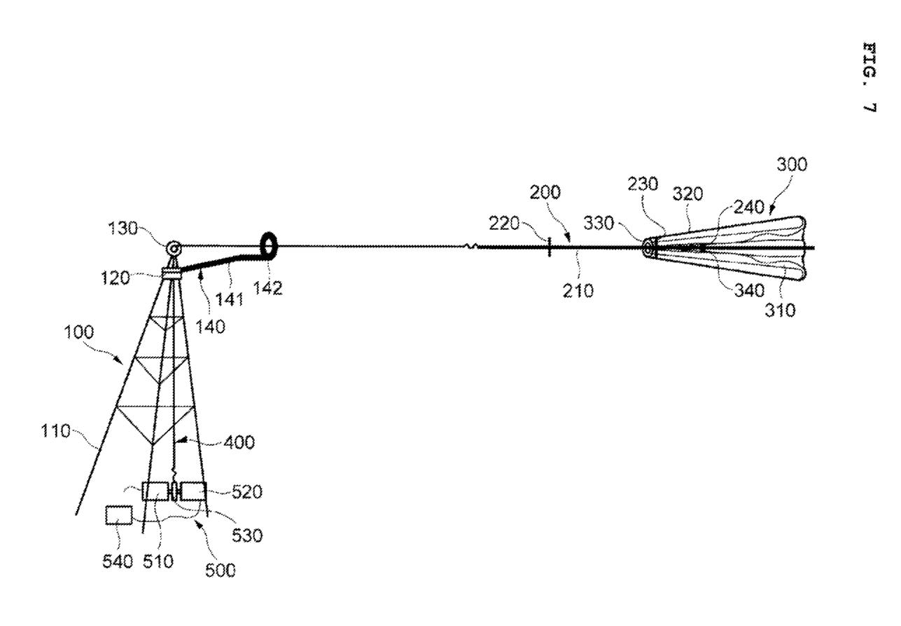

Next, when the movement of the shank post 210 in the downwind direction is stopped and the continuous wind pressure is applied to the canopy 310, the string ring 330 having the plurality of strings 320 connected thereto is released from the unwound mode latch 220 by means of the wind pressure. Thus, the string ring 330 is moved on the shank post 210 and supported by the wound mode latch 220. The folding of the canopy 310 is performed in the state in which the shank post 210 has been moved from the steel tower unit 100 to a maximum degree in the downwind direction as shown in FIG. 7. This state is called a wound mode start point.

Here, the canopy tap 340 included in the canopy 310 is fixed to the canopy tap fixture 240 included in the shank post 210, and the wound mode latch 230 is placed in a more downwind direction than the unwound mode latch 220 (i.e., a position distant from the steel tower unit 100). As the string ring 330 is moved from the unwound mode latch 220 to the wound mode latch 230, the canopy 310 is folded in the form of an umbrella that is turned inside out.

This state may be seen as a state in which the main rope 400 has been switched from the unwound mode to the wound mode. The string ring 330 is moved from the unwound mode latch 220 to the wound mode latch 230 by only the automatic release of the unwound mode latch 220. Accordingly, the canopy 310 connected to the shank post 210 is folded by only the wind pressure without additional power.

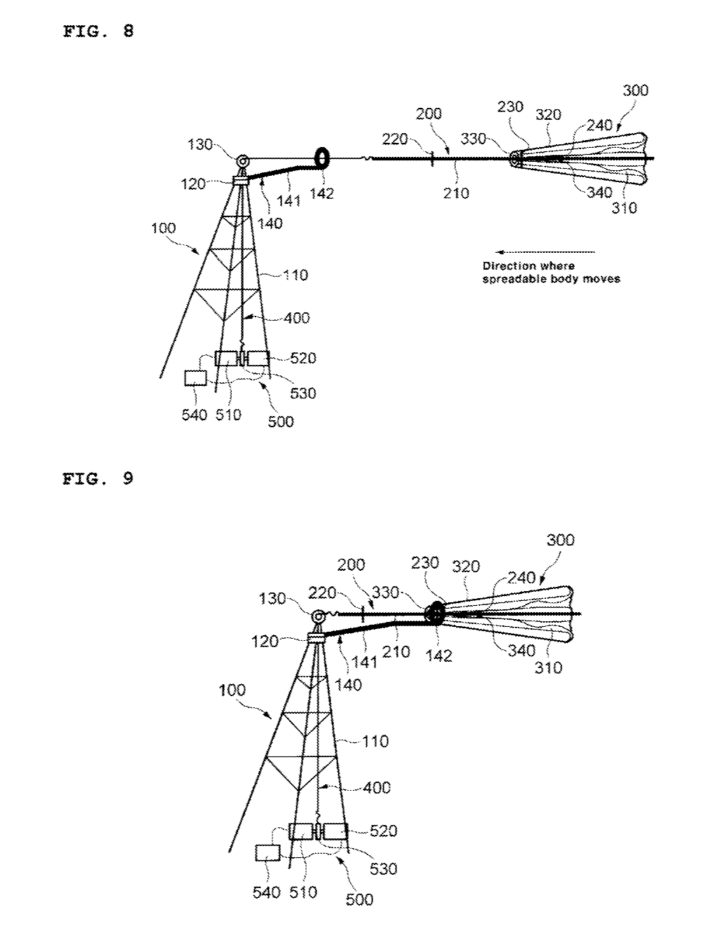

In the state in which the canopy 310 has been folded as described above, the area of the wind pressure applied to the canopy 310 is a minimum. At this time, the motor 520 included in the generating unit 500 is driven to wind the main rope 400 through the winch 530, thereby switching the mode to a wound mode, such as a state shown in FIG. 8.

In the wound mode, the wind pressure is applied to the minimum area of the canopy 310, and minimum wind power is applied to the main rope 400. Accordingly, the canopy 310, together with the shank post 210, is moved in an upwind direction as the main rope 400 is wound.

Thereafter, when the winding of the main rope 400 using the motor 520 continues, the spreadable body 300 and the shank unit 200 are moved to a position adjacent to the steel tower unit 100 as shown in FIG. 9, and the string ring 330 supported by the wound mode latch 230 is fixed to the string ring fixing pole 140 installed at the top of the steel tower unit 100. This state is called a wound mode end point.

Meanwhile, when tension is removed by releasing the main rope 400 in the state in which the string ring 330 has been fixed to the string ring fixing pole 140, wind pressure applied to the folded canopy 310 applies force to the canopy tap 340 and the canopy tap fixture 240 again in the downwind direction, the shank unit 200 having the canopy tap fixture 240 connected thereto is moved relatively in a downwind direction to the string ring fixing pole 140 having the string ring 330 fixed thereto, the unwound mode latch 220 supports the string ring 330 supported by the wound mode latch 230 by means of the wind pressure without additional power, and the canopy 310 is unfolded by the wind pressure. Accordingly, the unwound mode start point proceeds again as in FIG. 4. At this time, the unwound mode of the main rope 400 is performed by the release of the string ring 330 as in FIG. 5.

When tension applied to the main rope 400 becomes a specific value or higher by the canopy 310 unfolded in the shank post 210 as described above, the generating unit 500 generates electric power. When the canopy 310 is folded by the release of the unwound mode latch 220, the wind pressure applied to the canopy 310 becomes a minimum. Consequently, the tension of the main rope 400 is suddenly reduced and the output of generated electric power becomes a set value or lower.

A reduction in the tension of the main rope 400 is detected by the control plate 540. When a reduction in the tension is detected, the operation of the electric generator 510 is stopped and the motor 520 is driven to wind the main rope 400, so that the unfolding of the canopy 310 is performed again.

Accordingly, in the process in which the unwound mode and the wound mode are performed on the basis of the main rope 400, energy is obtained by means of a difference in the work which is generated by a difference in wind power according to the unfolding and folding of the canopy 310.

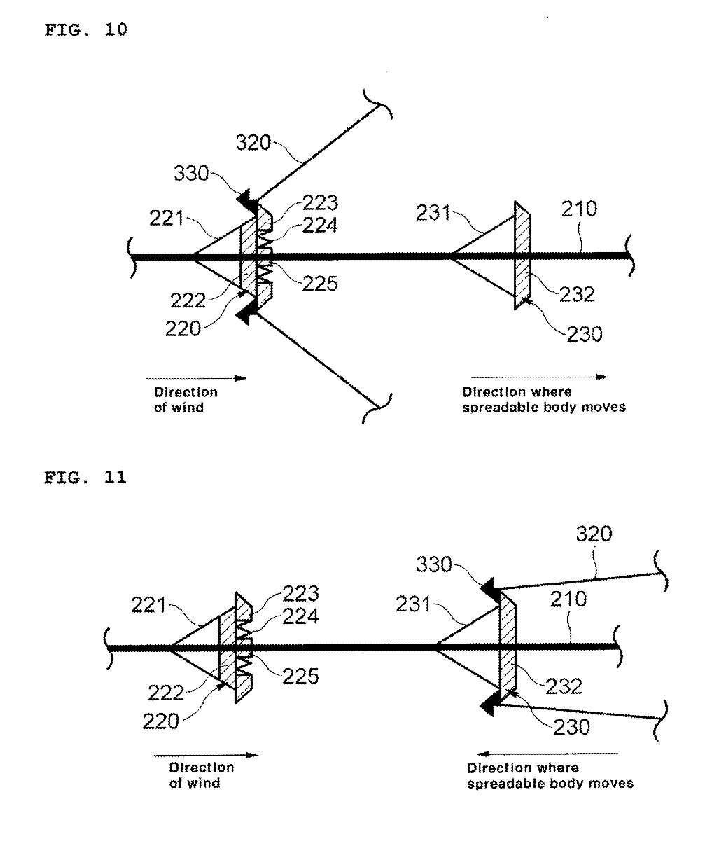

An operational process of the wind power generating apparatus having the above construction according to the present embodiment is described below with reference to FIGS. 10 to 16.

FIGS. 10 and 11 show positional relationships of the string ring to the shank unit which is adopted in the wind power generating apparatus according to the present invention. FIG. 10 shows a construction in the unwound mode state of the main rope, and FIG. 11 shows a construction in the wound mode state of the main rope.

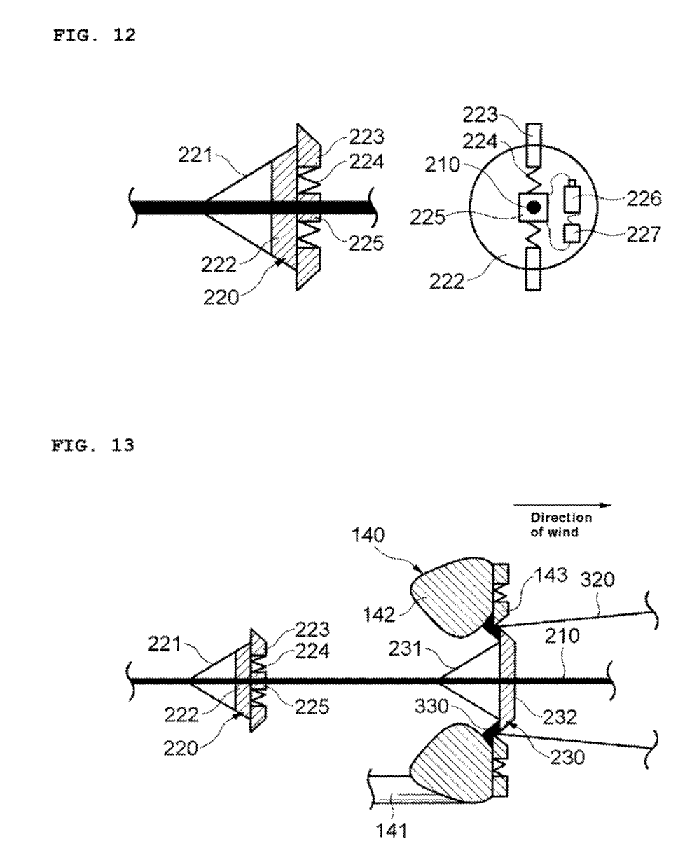

Furthermore, FIG. 12 is a detail diagram of the unwound mode latch which is applied to the wind power generating apparatus according to the present invention.

As shown, the unwound mode latch 220 is fixed to the shank post 210 of the shank unit 200 in an upwind direction (i.e., a direction opposite to the direction of the wind), and the wound mode latch 230 is fixed in a downwind direction on one side of the unwound mode latch 220.

In the unwound mode of the main rope 400, such as in FIG. 10, the string ring 330 having the plurality of strings 320 connected thereto has been fixed to the unwound mode latch 220. In this case, wind pressure applied from the canopy 310 to the strings 320 is transferred to the main rope 400 through the shank post 210.

Furthermore, FIG. 11 shows the wound mode state of the main rope 400 and shows a state in which the string ring 330 connected to the plurality of strings 320 is released from the unwound mode latch 220 of the shank post 210 and then fixed to the wound mode latch 230.

Electric power is generated by the electric generator as the main rope 400 is released by wind pressure in the unwound mode state. When the unwound mode latch 220 is released at a point at which the length of the main rope 400 is a maximum, the string ring 330 is moved on the shank post 210 by means of wind power applied to the canopy 310 and then fixed to the wound mode latch 230.

At this time, after a lapse of time when the unwinding length of the main rope 400 becomes a specific length, the string ring 330 fixed to the unwound mode latch 220 is released by the automatic release of the unwound mode latch 220 and then moved toward the wound mode latch 230.

Here, the string ring 330 is moved toward the wound mode latch 230 by means of the release of the unwound mode latch 220 and thus the canopy 310 is folded. In order for the canopy 310 not to be directed toward the surface of land with the canopy 310 being folded, a certain amount of wind power must be continuously applied to the canopy 310. It is preferred that the canopy 310 continue to maintain a horizontal state so that the amount of folding of the canopy 310 is controlled by adjusting an interval between the unwound mode latch 220 and the wound mode latch 230.

Each of the unwound mode latch 220 and the wound mode latch 230 has a circular plate form having a hollow portion therein. Guide plates 221 and 231 each having a cucullated form are connected to the respective unwound mode latch 220 and the wound mode latch 230. The guide plates 221 and 231 function to have the string ring 330 easily engaged with the rim portion of the wound mode latch 230 when the string ring 330 is moved from the unwound mode latch 220 to the wound mode latch 230 and to have connection easily induced along the incline planes of the guide plates 221 and 231 when the wound mode latch 230 approaches the string ring fixing pole 140.

Meanwhile, FIG. 12 shows a detailed construction of the unwound mode latch 220. The unwound mode latch 220 includes a circular fixing plate 222 connected to the shank post 210 and a latch 223 protruded to the surrounding of the fixing plate 222 and configured to fix the string ring 330. The unwound mode latch 220 further includes a spring 224 for elastically protruding the latch 223, an electromagnet 225 for releasing the latch 223 by electromagnetic force, and a power source 226 for supplying power to the electromagnet 225.

Furthermore, the unwound mode latch 220 may further include a timer 227 for determining the time when the power of the power source 226 is connected and the conical guide plate 221 for playing the role of a guide when the unwound mode latch 220 passes through the string ring fixing pole 140.

In the unwound mode latch 220 constructed as described above, after a lapse of time when the main rope 400 is released in a specific length in the unwound mode of the main rope 400 (i.e., the shank unit 200 is moved and thus the main rope 400 becomes distance at a specific distance from the steel tower unit 100), the timer 227 is driven. At this time, when the power source 226 is supplied to the electromagnet 225 and thus the latch 223 is released, the string ring 330 engaged with the unwound mode latch 220 is separated and thus fixed to the wound mode latch 230, so that the wound mode is started.

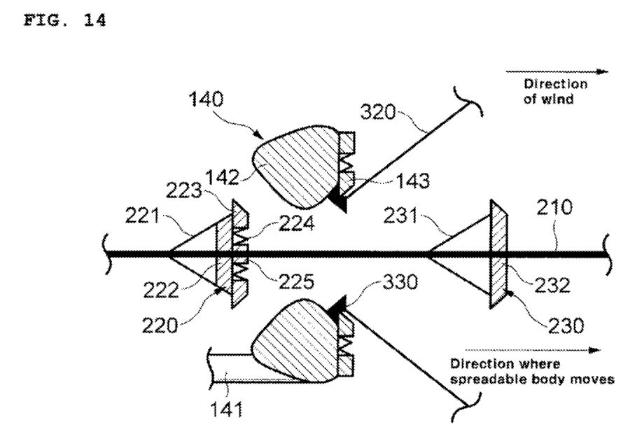

Next, FIG. 13 shows a positional relationship of the shank unit and the string ring to the string ring fixing pole at the wound mode end point which is applied to the wind power generating apparatus according to the present invention, FIG. 14 shows a positional relationship of the shank unit and the string ring to the string ring fixing pole from the wound mode end point to the unwound mode start point which is applied to the wind power generating apparatus according to the present invention, and FIG. 15 shows a positional relationship of the shank unit and the string ring to the string ring fixing pole at the unwound mode start point which is applied to the wind power generating apparatus according to the present invention.

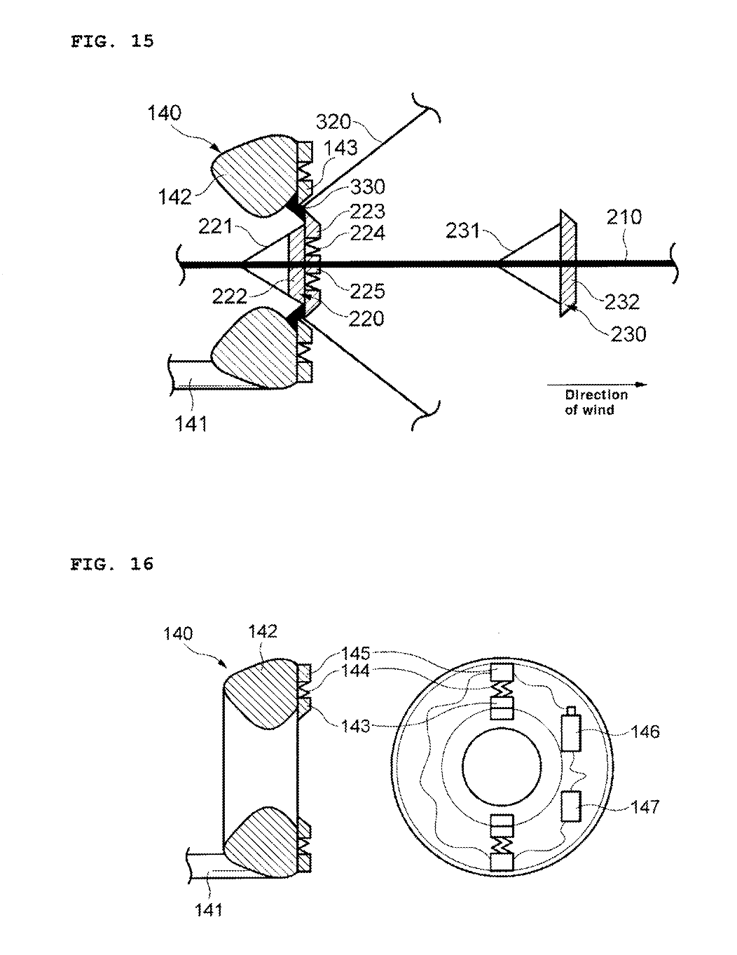

Furthermore, FIG. 16 shows a construction of the string ring fixing pole which is applied to the wind power generating apparatus according to the present invention.

As shown, in the wind power generating apparatus of the present embodiment, the string ring fixing pole 140 is mounted on the top of the bearing 120 installed in the steel tower unit 100 and is rotatably coupled thereto in the downwind direction like the shank post 210.

Accordingly, when the canopy 310 is moved to a position adjacent to the steel tower 110 by the movement of the shank post 210 in the wound mode, the string ring 330 connected to the shank post 210 is fixed to the string ring fixing pole 140.

Furthermore, the canopy 310 is unfolded by wind pressure when the main rope 400 is released at the wound mode end point shown in FIG. 13. At this time, the canopy tap 240 fixed to the canopy tap fixture 340 is subjected to force according to the wind pressure and the shank unit 200 is moved in the downwind direction. Accordingly, the string ring 330 is fixed to the unwound mode latch 220 through the intermediate process shown in FIG. 14, as shown in FIG. 15.

This is described in more detail. As the main rope 400 is wound by the driving of the motor 520, the string ring 330 fixed to the wound mode latch 230 in the wound mode is moved in an upwind direction, moved to a position adjacent to the support units 110, and then fixed to the string ring fixing pole 140 installed in the steel tower unit 100, thus maintaining the wound mode end point state.

When the main rope 400 is unwound in the state in which the string ring 330 is fixed to the string ring fixing pole 140 as described above, wind pressure is applied to the folded canopy 310 and thus the canopy 310 is unfolded. The wind pressure applied to the canopy 310 is transferred to the shank post 210 through the canopy tap fixture 340, thereby moving the shank post 210 in the downwind direction.

Thereafter, the unwound mode latch 220 and the wound mode latch 230 are moved by wind pressure without additional power at the same time in a relative downwind direction to the string ring 330 which is fixed to the string ring fixing pole 140. This state is shown in FIG. 14. The unwound mode start point state in which the string ring 330 is fixed to the unwound mode latch 220 after the unwound mode latch 220 and the wound mode latch 230 are moved is shown in FIG. 15.

When the string ring fixing pole 140 is released at the unwound mode start point, the string ring 330 is separated from the string ring fixing pole 140, the string ring 330 is subjected to force in the downwind direction by means of the tension of the strings 320 according to the wind pressure applied to the canopy 310, and the force is transferred to the main rope 400 via the unwound mode latch 220. It results in the unwound mode state in which the main rope 400 is unfolded to generate electric power.

Meanwhile, the construction of the string ring fixing pole 140 adopted in the wind power generating apparatus of the present embodiment is described in more detail with reference to FIG. 16.

The string ring fixing pole 140 shown in FIG. 16 may include a support 141 fixed to the top of the bearing 120 installed in the steel tower unit 100, the rope guidance ring 142 of a doughnut shape formed in the support 141, and a latch 143 to which the string ring 330 may be fixed.

The string ring fixing pole 140 further includes a spring 144 for maintaining the latch 143 in a locking state by means of elasticity with power being not supplied, an electromagnet 145 for maintaining the latch 143 in a release state by means of electromagnetic force, a power source 146 for supplying power to the electromagnet 145, and a timer 147 for determining the time when the power source 146 is connected.

In the string ring fixing pole 140 constructed as described above, the string ring 330 is fixed, and the control plate 540 included in the generating unit 500 detects the fixing state of the string ring 330 and thus detects a wound mode end point state, such as that shown in FIG. 13. Next, the control plate 540 blocks the supply of power to the motor 520 of the generating unit 500, and thus the tension of the main rope 400 wound through the motor 520 is released, so that the main rope 400 proceeds to the unwound mode.

In the unwound mode start point, such as that shown in FIG. 15, the timer 147 is actuated and thus the power source 146 is supplied to the electromagnet 145. Accordingly, the latch 143 is released and the string ring 330 is separated from the string ring fixing pole 140, so that the unwound mode can be started.

Meanwhile, a process in which the timer 227 on the unwound mode latch 220, operated in conjunction with the timer 147 of the string ring fixing pole 140 shown in FIG. 16, recognizes the time when the unwound mode is started is as follows.

The unwound mode latch 220 is moved in a relatively downwind direction to the string ring 330 and the string ring fixing pole 140 from the wound mode end point to the unwound mode start point. A contact of the latch 223 of the unwound mode latch 220 with the rope guidance ring 142 of the string ring fixing pole 140 and the string ring 330 is detected, and this time becomes the unwound mode start point. Each of the timer 227 of the unwound mode latch 220 and the timer 147 of the string ring fixing pole 140 recognizes the detection time as the unwound mode start point and uses the detection time as the time when the entire process is started.

The preferred embodiments of the present invention are disclosed for illustrative purposes, and those skilled in the art to which the present invention pertains may substitute, modify, and change the present invention in various ways without departing from the scope of the technical spirit of the present invention. However, the substitution, change, etc. may be seen to fall within the scope of the following claims.

1. A wind power generating apparatus using an automatically foldable canopy, comprising:
a steel tower unit supported on a ground and installed to a specific height;
a shank unit connected to a top of the steel tower unit and installed in a horizontal direction;
a spreadable body equipped with the canopy which repeats folding and unfolding in a downwind direction on the shank unit;
a main rope configured to connect a plurality of strings to a rim of the canopy and extended to the steel tower unit; and
a generating unit installed in the steel tower unit and configured to generate energy by a difference in a wind pressure between a wound mode and an unwound mode of the main rope.

2. The wind power generating apparatus according to claim 1, wherein the steel tower unit comprises:
support units supported on the ground in a vertical direction,
a bearing connected to a top of the support units and configured to enable horizontal rotation in the downwind direction,
a pulley mounted on a top of the bearing and configured to guide a transfer of the main rope, and
a string ring fixing pole configured to fix the string ring, connected to the strings, to the support units.

3. The wind power generating apparatus according to claim 1, wherein the shank unit comprises:
a shank post configured to have the canopy connected thereto so that the canopy is unfoldable and foldable,
an unwound mode latch and a wound mode latch installed in the shank post and configured to move the spreadable body in the unwound or wound mode of the main rope and to have a string ring, connected to the strings, engaged with the shank post, and
a canopy tap fixture configured to have a canopy tap, mounted on the canopy, fixed to the shank post.

4. The wind power generating apparatus according to claim 1, wherein the spreadable body comprises:
the canopy configured in an umbrella form,
a specific number of the strings connected to the canopy,
a string ring configured to gather and connect the strings, and
a canopy tap placed at a vertex of the canopy.

5. The wind power generating apparatus according to claim 1, wherein the generating unit comprises:
an electric generator configured to generate electric power in the unwound mode of the main rope,
a motor configured to wind the main rope using motive power in the wound mode of the main rope,
a winch connected to the electric generator and the motor and configured to wind or unwind the main rope by rotation, and
a control plate configured to control the rotation of the winch.

6. The wind power generating apparatus according to claim 3, wherein:
the unwound mode latch has the string ring engaged therewith or automatically released therefrom by means of wind pressure applied to the canopy in the unwound mode of the main rope, and
the wound mode latch has the string ring, released from the unwound mode latch, engaged therewith and fixed thereto in the wound mode of the main rope.

7. The wind power generating apparatus according to claim 3, wherein:
the canopy is moved in the downwind direction by a release of the unwound mode latch and folded in an umbrella form that is turned inside out, and
the string ring supported by the unwound mode latch is moved to one side along with the canopy and supported by the wound mode latch.

8. The wind power generating apparatus according to claim 2, wherein the string ring fixing pole comprises:
a support fixed to a top of the bearing installed in the steel tower unit,
a rope guidance ring of a doughnut shape fixed to the support,
a latch configured to have the string ring fixed thereto,
a spring configured to maintain the latch in a locking state by elasticity with power not supplied thereto,
an electromagnet configured to maintain the latch in a release state by electromagnetic force,
a power source configured to supply power to the electromagnet, and
a timer configured to determine a time when the power is connected.

9. The wind power generating apparatus according to claim 7, wherein the canopy continues to maintain a horizontal state so that an amount of the folding of the canopy is controlled by adjusting an interval between the unwound mode latch and the wound mode latch.

10. The wind power generating apparatus according to claim 9, wherein:
each of the unwound mode latch and the wound mode latch has a circular plate form having a hollow portion therein, and
guide plates each having a cucullated form are connected to the respective unwound mode latch and the wound mode latch.

11. The wind power generating apparatus according to claim 3, wherein the shank post formed of a bar-shaped rod or a string is inserted into the canopy when the canopy is initially installed and fixed through the canopy tap fixture.

12. The wind power generating apparatus according to claim 10, wherein the unwound mode latch comprises:
a circular fixing plate connected to the shank post,
a latch protruded to a surrounding of the fixing plate and configured to fix the string ring,
a spring configured to elastically protrude the latch,
an electromagnet configured to release the latch by electromagnetic force, and
a power source configured to supply power to the electromagnet.
